(19) United States
(12) Patent Application Publication
(10) Pub. No.: US 2026/0362053 A1
(43) Pub. Date: Nov. 12, 2026

(54) SYSTEMS AND METHODS FOR RECONSTRUCTING AUDIO PRESENT IN AN ENVIRONMENT

(71) Applicant: Varjo Technologies Oy, Helsinki (FI)

(72) Inventors: Ville Timonen, Helsinki (FI); Mika-Petteri Lundgren, Salo (FI); Oliver Merilaid, Helsinki (FI)

(73) Assignee: Varjo Technologies Oy, Helsinki (FI)

(21) Appl. No.: 19/204,834

(22) Filed: May 12, 2025

(51) Int. Cl. H04R 1/40; G06F 16/68; G06F 16/687

(52) U.S. Cl. CPC H04R 1/406; G06F 16/686; G06F 16/687

(57) ABSTRACT

A system for reconstructing audio present in environment, system including devices and host computing platform. Each device including audio sensor configured to detect sound signals; location sensor(s) configured to determine location of each of devices in environment; and processor configured to: process detected sound signals and generate data stream comprising sound signals and metadata; and transmit generated data stream to host computing platform upon occurrence of predefined condition. The host computing platform configured to: receive data stream and metadata from each of devices; determine location of sound source(s) relative to each of devices; cross-reference determined location of sound source(s) relative to each of devices to determine a spatial location of sound source(s); and generate and output spatial audio model representing position of sound source(s) within unified spatial coordinate system.

### TECHNICAL FIELD

The present disclosure relates to spatial audio reconstruction and signal processing. More specifically, it pertains to systems and methods for multi-device audio localization and synchronization in immersive extended reality (XR) environments. The present disclosure relates to systems and methods for reconstructing audio present in environments.

### BACKGROUND

Immersive extended reality (XR) applications rely heavily on accurate spatial audio reconstruction to deliver a realistic and coherent experience. For these applications, the direction and location of audio sources must align with their physical counterparts in the environment to support user interaction and immersion. A mismatch between the auditory and visual domains can result in cognitive dissonance, degrading the realism of XR experiences and reducing their overall effectiveness.

Typically, existing spatial audio systems employ a single-device setup—such as a head-mounted display or a microphone array—to determine the direction of sound sources. These systems often utilize beamforming, head-related transfer functions (HRTFs), or phase-based methods to estimate direction. However, such approaches are inherently limited in resolving the depth or true location of a sound source, particularly in complex or dynamic environments. The lack of accurate distance estimation limits the system's ability to fully reconstruct the soundscape, leading to a flattened or ambiguous auditory field. This restricts spatial immersion and degrades the perceived quality of XR, surveillance, and simulation systems.

Moreover, single-device solutions are prone to occlusion and environmental noise, and often lack the spatial diversity needed to triangulate sound source positions reliably. The use of fixed microphone geometries also introduces rigidity that reduces adaptability in multi-user or large-scale environments.

Therefore, in the light of the foregoing discussion, there is a need to overcome the aforementioned limitations to enhance sound source localization and spatial accuracy in real-time applications.

### SUMMARY

The aim of the present disclosure is to provide a system and a method to reconstruct audio present in an environment using a multi-device approach that enables accurate spatial localization of sound sources and synchronized spatial audio modelling. The aim of the disclosure is achieved by a system and a method for reconstructing audio present in an environment, as defined in the appended independent claims, wherein each of a plurality of devices detects sound signals, associates metadata including location and time, and transmits a data stream to a host computing platform for real-time spatial analysis.

The embodiments of the present disclosure substantially enable to improve spatial resolution, localization accuracy, and energy efficiency in immersive environments such as XR by leveraging synchronized data streams and triangulation techniques.

In one or more embodiments, each device in the system comprises at least one audio sensor and one location sensor, and is configured to generate time-stamped and location-tagged data which is sent to the host platform based on a predefined condition.

The host platform then processes the received data to determine the direction and spatial location of at least one sound source, using triangulation and cross-referencing methods based on relative positions of the devices.

The reconstructed spatial audio model generated by the host platform represents the position, directionality, and characteristics of the sound source within a unified spatial coordinate system.

Optionally, the devices can include additional elements such as temperature sensors to calibrate the speed of sound based on ambient conditions, thereby improving localization precision.

In some implementations, the system also supports interaction between localized sound sources and virtual objects or agents in XR environments, enabling more immersive and context-aware experiences.

Further, the use of predefined triggering conditions for data transmission allows the system to conserve bandwidth and processing power, making it suitable for deployment in large or dynamic environments.

The aim of the present disclosure is achieved by a system and a method for reconstructing audio present in an environment, as defined in the appended independent claims to which reference is made to. Additional aspects, advantages, features and objects of the present disclosure would be made apparent from the drawings and the detailed description of the illustrative embodiments constructed in conjunction with the appended claims that follow.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 illustrates an exemplary schematic illustration of an environment where a system for reconstructing audio present in said environment is used, in accordance with an embodiment of the present disclosure;

FIG. 2 illustrates a block diagram of a system for reconstructing audio present in an environment, in accordance with an embodiment of the present disclosure; and

FIG. 3 illustrates steps of a method for reconstructing audio present in an environment, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, the present disclosure provides a system for reconstructing audio present in an environment, the system comprising: a plurality of devices, each device comprising:
an audio sensor operable to detect sound signals;
at least one location sensor operable to determine a location of each of the plurality of devices in the environment; and
a processor operable to:
   process the detected sound signals and generate a data stream comprising the sound signals and a metadata, wherein the metadata comprises timestamps of the detected sound signals and the location data of the device; and
   transmit the generated data stream to a host computing platform upon occurrence of a predefined condition; and
the host computing platform operable to:
   receive the data stream and the metadata from the each of the plurality of devices;
   determine a location of at least one sound source relative to each of the plurality of devices based on the received data streams and the metadata;
   cross-reference the determined location of the at least one sound source relative to each of the plurality of devices to determine a spatial location of the at least one sound source; and
   generate and output a spatial audio model representing the position of the at least one sound source within a unified spatial coordinate system.

In a second aspect, the present disclosure provides a method for reconstructing audio present in an environment, a method being implemented by a system comprising a plurality of devices and a host computing platform, wherein each of the plurality of devices comprises an audio sensor operable to detect sound signals, and at least one location sensor, wherein the method comprises:
receiving data stream and metadata from the each of the plurality of devices, the data stream being generated by processing the detected sound signals, wherein the data stream comprises the sound signals and the metadata, and the metadata comprises timestamps of the detected sound signals and the location data of the device, wherein the data stream is received upon occurrence of a predefined condition;
determining a location of at least one sound source relative to each of the plurality of devices based on the received data stream and the metadata;
cross-referencing the determined location of the at least one sound source relative to each of the plurality of devices to determine a spatial location of the at least one sound source; and
generating and outputting a spatial audio model representing the position of the at least one sound source within a unified spatial coordinate system.

In operation, each device captures ambient sound and associates it with precise spatial and temporal metadata. This information is bundled into a structured data stream, which is only transmitted to the host computing platform when a predefined condition is met, such as a sound event exceeding a threshold or an external request. The host computing platform processes the collected data streams, identifies patterns in timestamp and location information, and resolves the spatial location of sound sources by comparing these observations across multiple devices. By cross-referencing, the platform performs spatial triangulation to locate sound sources within a unified coordinate space. The spatial audio model generated thereafter supports immersive applications, enabling users or virtual agents to perceive sound directionality and positioning with high fidelity.

The method mirrors the system logic in procedural steps. It's suitable for both real-time runtime systems or post-processing environments. Modular flow enables each step to be optimized individually for different applications.

The present disclosure provides the aforementioned first aspect and the aforementioned second aspect for reconstructing the audio present in the environment. It will be appreciated that utilizing the plurality of devices each equipped with the audio sensor and the at least one location sensor, the system enables a distributed and collaborative approach for reconstructing the audio in the environment. Unlike conventional single-device systems, this multi-device configuration allows for accurate triangulation of the at least one sound source, improving depth perception and overall spatial accuracy. The inclusion of the metadata comprising timestamps and location data ensures precise synchronization of the sound signals, thereby reducing errors in localization of the at least one sound source. Moreover, the system optimizes power and bandwidth usage by transmitting the data stream only upon occurrence of the predefined condition, rather than continuously streaming audio, making it energy-efficient and scalable for larger environments. Beneficially, centralized processing at the host computing platform allows for robust cross-referencing of spatial audio data, enabling highly accurate reconstruction of the audio in the environment. This capability makes the system particularly effective in applications such as extended reality (XR), surveillance, acoustic mapping, and similar, where precise real-time audio localization is essential.

Furthermore, the method ensures that the sound signals, timestamps, and location data from each device amongst the plurality of devices are accurately received, processed, and cross-referenced to determine the location of the at least one sound source within the environment. By leveraging time-synchronized data streams, the method effectively eliminates uncertainties in sound positioning, enhancing real-time responsiveness. Additionally, the method ensures that the spatial audio model is accurately generated and output based on the metadata from the plurality of devices, allowing precise rendering of the audio relative to the environment. Such an approach of the method ensures scalability, adaptability, and high precision, making it suitable for dynamic environments where the at least one sound source and listening devices may be moving. The system and the method are fast, robust, easy to implement, and facilitate accurate real-time audio reconstruction with high accuracy.

Throughout the present disclosure, the term “environment” refers to a given space in which the sound signals are present and can be detected by the system. Said given space may be indoors or outdoors and can include dynamic elements or static elements that influence acoustic propagation, such as walls, obstacles, varying atmospheric conditions, and the like. For example, in indoor environments, the presence of reflective surfaces may cause reverberations or multipath propagation, which can affect clarity and timing of the received sound signals. Accordingly, the system may apply filtering or signal conditioning techniques, for example, such as spatial filtering, reverberation suppression, and the like, to mitigate impact of reflections and enhance the accuracy of sound source localization and analysis. The environment serves as an operational domain in which the plurality of devices function to capture, process, and reconstruct the sound signals relative to their spatial positions.

Throughout the present disclosure, the term “device” refers to an electronic device or a computational unit equipped with at least one audio sensor that is capable of detecting the sound signals within the environment. In an implementation, each device amongst the plurality of devices comprises at least one audio sensor, the at least one location sensor, and the processor. Optionally, each device amongst the plurality of devices comprises a temperature sensor. Optionally, the plurality of devices comprise at least two of: a head-mounted display device, a user-interaction controller, a tracking puck, a wearable device. Including multiple device types provides redundancy and diverse perspectives. This enhances accuracy and robustness in multi-user or cluttered environments. In this regard, the term “head-mounted display device” refers to a specialized equipment that is configured to present an extended reality (XR) environment to a user when said HMD, in operation, is worn by the user on their head. The head-mounted display (HMD) device is implemented, for example, as an XR headset, a pair of XR glasses, and the like, that is operable to display a visual scene of the XR environment to the user. It will be appreciated that when a given device amongst the plurality of devices is the HMD, it enables immersive user experiences by directly engaging in the user's field of view, allowing for seamless integration of virtual or augmented content with the physical world, improving interaction and immersion of the user. Moreover, the term “user-interaction controller” refers to a handheld or a body-worn input device designed to facilitate interaction with a computing system, within virtual reality (VR), augmented reality (AR), or gaming environment. The user-interaction controller may include hand-held input mechanisms such as buttons, triggers, touchpads, joysticks, haptic feedback mechanisms, motion sensors, and similar components, to capture user inputs. Optionally, the system may support hand tracking means, wherein the user's hands are tracked using optical or depth sensors, enabling natural interaction with the virtual reality or mixed reality environment through gestures such as pinching, grabbing, or pointing. This allows for immersive, controller-free interaction, particularly beneficial for intuitive XR experiences. The user-interaction device can communicate wirelessly or via a wired connection with the system to enable gesture-based controls, motion tracking, and tactile feedback. Moreover, the term “tracking puck” refers to a compact, an attachable electronic device designed to enable spatial tracking of non-standard objects within a virtual or augmented reality system. The tracking puck is equipped with the at least one audio sensor that allow the system to determine its position and orientation within the environment. The tracking puck can be mounted on physical objects, such as props, tools, or user limbs, to facilitate real-time tracking and interaction within a virtual environment. Moreover, the term “wearable device” refers to an electronic device designed to be worn on a body of a given user, to facilitate motion tracking, biometric sensing, or user interaction within an immersive computing environment. Examples of the wearable device may include, but are not limited to, a smart glove, a wristband, a sensor-equipped clothing, and a motion-capture suit. The wearable is equipped with the at least one audio sensor that allows the system to determine its position and orientation within the environment. The all aforesaid types of the plurality of devices are well-known in the art.

A technical effect of the plurality of devices comprising at least two of: the head-mounted display device, the user-interaction controller, the tracking puck, the wearable device is that the system enhances accuracy of the at least one sound source localization and spatial mapping. The integration of different device types ensures that the audio is captured from various perspectives within the environment, improving depth perception, reducing occlusion-related errors, and providing a more comprehensive spatial representation of the audio. Additionally, the system benefits from increased redundancy and robustness, ensuring reliable audio reconstruction even in dynamic environments where the plurality of devices may move or encounter obstructions. This approach enhances immersive experiences in XR, improves situational awareness in surveillance applications, and facilitates precise acoustic mapping for various real-world use cases.

Throughout the present disclosure, the term “audio sensor” refers to a device capable of detecting and capturing sound waves within the environment and converting them into electrical signals for further processing. Examples of the audio sensor may include, but are not limited to, a microphone, and an ultrasonic microphone. The term “sound signal” refers to a propagating acoustic wave that travels through a medium (e.g., air, and similar) and is characterized by variations in pressure over time. The sound signal may be generated by an external source, an event occurring in the environment, or an active emission from a given device for tracking purposes. The sound signal has key parameters such as a frequency, an amplitude, a phase, and a propagation speed, which influence how it is detected and processed by the at least one audio sensor.

In an implementation, the at least one audio sensor is attached with each device amongst the plurality of devices to detect the sound signals incident thereon and generate corresponding timestamped sensor data for further processing. In other words, the at least one audio sensor is a part of a given device amongst the plurality of devices. In this regard, each audio sensor passively detects the sound signals that are emitted from at least one source (described later) or generated by an event in the environment. The detected sound signals can include naturally occurring sounds, specifically generated acoustic signals intended for localization, and similar. When a sound signal is detected, the at least one audio sensor records a precise timestamp indicating when said sound signal was received. Such an approach improves sound localization accuracy, reduces errors due to environmental noise, and allows for real-time reconstruction of the audio in the environment. The combination of multiple audio sensors across different devices enhances robustness, enabling operation in dynamic environments where both sound sources and devices may be in motion. The sensor data being recorded by the at least one audio sensor, including timestamps, is sent to the processor for further processing.

It will be appreciated that the plurality of devices each equipped with the at least one audio sensor, provides a distributed and collaborative approach to spatial audio reconstruction. Such an approach enhances accuracy of sound localization by enabling multi-point triangulation instead of relying on a single device. The system effectively reduces errors caused by occlusions, reflections, and environmental noise, thereby leading to improved depth perception and spatial resolution.

Optionally, the audio sensor comprises at least a microphone, an acoustic camera. The acoustic camera allow visualization and high-resolution localization of complex sound fields. The microphone provides real-time signal data. Their combination supports advanced use cases such as debugging, performance capture, or industrial monitoring. In this regard, the term “microphone” refers to an electronic device designed to capture sound waves from the environment and convert them into electrical signals. Optionally, a given audio sensor may be selected from a microphone array, wherein said microphone array comprises multiple spatially distributed microphones that work collectively to capture the sound signals from various directions within the environment. It will be appreciated that the microphone array allows for real-time capture of the sound signals, thereby enhancing ability of the system to accurately determine the direction and origin of the at least one sound source within the environment, depending on factors, for example, such as array geometry, frequency characteristics of the sound, and the acoustic properties of the environment. By leveraging spatial filtering and beamforming techniques, the microphone array improves signal-to-noise ratio, reducing interference from unwanted background noise. Moreover, the term “acoustic camera” refers to a device that integrates an array of microphones with signal processing algorithms to capture, visualize, and localize the at least one sound source within the environment. The acoustic camera is used for tasks such as identifying noise sources, sound field visualization, and detailed acoustic analysis in environments like industrial plants, automotive testing, building acoustics, and similar. The principle operation of the aforesaid types of the audio sensor is well-known in the art.

A technical effect of the audio sensor comprising at least the microphone, the acoustic camera, is that it enhances ability of the system to accurately capture and process the sound signals by providing versatile audio sensing capabilities.

Throughout the present disclosure, the term “location sensor” refers to a sensor that is operable to determine the location of a given device amongst the plurality of devices within the environment. The at least one location sensor generates the location data that may be used to define spatial coordinates of the given device relative to the predefined coordinate system. The at least one location sensor may be implemented using technologies such as inertial measurement units (IMUs), optical tracking systems, Global Positioning System (GPS), ultra-wideband (UWB), LIDAR, or other positioning technologies. The location data provided by the at least one location sensor enables accurate tracking and spatial referencing of the given device for applications requiring precise localization. It will be appreciated that ability of the system to determine the location of each device amongst the plurality of devices ensures better synchronization and calibration, resulting in a more accurate and immersive auditory experience in applications such as XR, surveillance, acoustic mapping, and similar.

Throughout the present disclosure, the term “processor” refers to a computational element that is operable to execute the software framework. Examples of the processor may include, but are not limited to, a microprocessor, a microcontroller, a complex instruction set computing (CISC) microprocessor, a reduced instruction set computing (RISC) microprocessor, a very long instruction word (VLIW) microprocessor, digital signal processor (DSP), central processing unit (CPU), Field Programmable Gate Array (FPGA), or any other type of processing circuit.

Throughout the present disclosure, the term “data stream” refers to a continuous flow of structured or unstructured data that is transmitted, processed, or stored in real-time or near real-time. Herein, the data stream comprises the sound signals detected by the at least one audio sensor and associated metadata. The data stream facilitates sequential processing, synchronization, and integration of the sound signals from the at least one sound source, allowing for accurate reconstruction and localization of the audio within the environment. The term “metadata” refers to auxiliary data that provides contextual information about primary data to facilitate its interpretation, processing, and correlation. Herein, the metadata comprises timestamps of the detected sound signals and the location data of the given device that recorded the sound signals. The metadata enhances accuracy of the system by enabling precise temporal and spatial alignment of the sound signals, improving ability to reconstruct the audio within the environment. Herein, the term “location data” refers to a data representing spatial position of a given device amongst the plurality of devices within the predefined coordinate system. For example, the location data may include, but are not limited to, absolute position coordinates or relative position coordinates (e.g., Cartesian coordinates, latitude/longitude, polar coordinates, and the like), orientation angles (e.g., a pitch, a roll, and a yaw), a velocity, and a motion trajectory.

Herein, the processor processes the incoming sound signals detected by the at least one audio sensor and assigns a timestamp to each detected signal. Additionally, the processor retrieves the location data from the at least one location sensor associated with each device amongst the plurality of devices. The processor then combines this information into a structured data stream, which is transmitted for further processing. Said data stream serves as basis for determining the spatial location of the at least one sound source when correlated with data from other devices in the system. A technical effect of generating the data stream comprising the sound signals and the metadata is that it improves accuracy in sound localization and reconstruction. By ensuring that each detected sound signal is timestamped and associated with precise location data, the system can effectively correlate sound information from the plurality of devices. This results in enhanced spatial resolution, reduced errors due to synchronization issues, and better real-time performance in applications such as XR, surveillance, acoustic mapping, and the like.

Optionally, the location data from the location sensor is dynamically updated to reflect changes in the position of each of the plurality of devices. In this regard, the at least one location sensor continuously measures the position and/or orientation of each device amongst the plurality of devices. The at least one location sensor generates updated location data in a form of spatial coordinates, a velocity, an acceleration, and orientation changes. The processor receives said updated location data from the at least one location sensor and may apply filtering techniques (e.g., Kalman filter, complementary filter, and the like) to enhance accuracy and mitigate measurement errors. Optionally, if multiple location sensors are used, the processor may fuse data from different sources (i.e., sensor fusion) to improve localization precision. The processor then compares the updated location data with previous position data to detect a movement, a drift, or positional changes of the given device amongst the plurality of devices. Herein, if a significant change is detected, the processor may recalibrate and adjust spatial coordinates, accordingly, ensuring accurate real-time tracking. In this regard, the processor dynamically updates the location of each of the plurality of devices within the environment. The updated location data ensures that the processor correctly maps the sound signals to real-time positions of each of the plurality of devices. Optionally, if required, the processor may transmit the dynamically updated location data to the host computing platform for centralized processing, further improving real-time tracking and system coordination. Real-time positional updates ensure audio data remains correctly geotagged even as devices move. Sensor fusion (e.g., IMU+optical tracking) supports 6DOF tracking. This enables accurate tracking in dynamic XR setups and maintains audio realism in user movement.

A technical effect of the aforementioned feature is that the system continuously adapts to positional changes of each device amongst the plurality of devices, ensuring accurate real-time localization and synchronization. Such an approach enhances spatial awareness, improves system coordination, and enables precise mapping of the sound signals or interactions in applications such as XR, surveillance, acoustic environments, and similar.

Throughout the present disclosure, the term “host computing platform” refers to a computing system that is configured to receive, process, and integrate the data stream from the plurality of devices within the environment. The host computing platform may comprise one or more processors, a memory, a storage, and communication interfaces to facilitate real-time or near-real-time processing of received data. The host computing platform is operable to execute algorithms for audio reconstruction, spatial localization, metadata correlation, and overall system coordination. The host computing platform may be implemented as a local computing device for example, a desktop computer, a server, an edge computing node, a remote cloud-based system, and the like. The term “predefined condition” refers to a specific criterion or a set of criteria that must be satisfied for an event to be triggered within the system. The predefined condition may be configured based on threshold values, temporal constraints, detection of specific sound patterns, changes in device status, external commands, and similar. Examples of the predefined condition may include, but are not limited to, detection of a sound signal with an amplitude exceeding a certain level in a specific frequency range, accumulation of a certain amount of audio data before transmission, occurrence of a time-based trigger (such as periodic data transmission at fixed intervals), and an external trigger from the host computing platform requesting data transmission.

Herein, the processor monitors for occurrence of the predefined condition. When the predefined condition is met, the processor initiates data transmission by sending the generated data stream to the host computing platform over a wired communication network or a wireless communication network. The host computing platform then integrates data from the plurality of devices to process, reconstruct, and localize the sound signals within the environment. In an implementation, the host computing platform is communicably coupled to the plurality of devices, enabling efficient data synchronization, real-time processing, and adaptive decision-making based on incoming data.

Optionally, the predefined condition comprises at least one: detecting, at the processor, that a triggering condition has been met, wherein the triggering condition is based on an input signal from one or more sensors, and in response, transmitting the data stream to the host computing platform;
receiving, at the processor, a request from the host computing platform to transmit the data stream;
compressing the data stream before transmission.

This condition-based approach reduces bandwidth and power usage. For instance, sound above a threshold or a host request may trigger data upload. It enhances energy efficiency and scalability, especially in systems with dozens of devices.

In this regard, the term “input signal” refers to an analog signal or a digital signal received by the processor from the one or more sensors. The input signal may be characterized by parameters such as an amplitude, a frequency, a duration, and a waveform. Optionally, the input signal comprises at least one of: a sound signal based on at least one factor (e.g., an environmental noise, a predefined acoustic event, and the like), a visual input detected by a given device. Herin, the one or more sensors comprises at least one of: an audio sensor, an optical sensor (i.e., a camera, an infrared sensor, and the like). When the input signal is the sound signal, it is detected by the audio sensor and converted into an electrical or digital format for processing. Optionally, when the input signal is the visual input, it is detected by the optical sensor, which captures an image or a video data for analysis. In this regard, once the triggering condition has been met, the processor transmits the data stream to the host computing platform.

Optionally, before transmitting the data stream, the processor evaluates whether compression is required based on factors such as available bandwidth of the communication channel, storage or memory constraints, power efficiency requirements, system-defined policies for data optimization, and similar. In this regard, the processor may select an appropriate compression algorithm based on type of data in the stream. Common compression techniques may include such as lossless compression (for example, such as Free Lossless Audio Codec (FLAC), Huffman coding, Run-Length Encoding, and the like) for preserving original data integrity, lossy compression (e.g., MP3, Advanced Audio Codec (AAC)) for reducing file size while maintaining acceptable quality, and similar. If the data stream includes both the sound signals and the metadata, a hybrid approach may be used where metadata is losslessly compressed, and the sound signals are selectively compressed based on system constraints. Optionally, the processor encodes the data stream using selected compression algorithm. Herein, compression may involve, reducing redundant information within the sound signals, encoding the metadata efficiently to minimize overhead, applying adaptive compression techniques, where different levels of compression are used depending on data significance, and similar. After compression, the processor may validate the compressed data to ensure it meets transmission requirements of the system. Then, the processor transmits the generated metadata to the host computing platform. It will be appreciated that such an approach optimizes transmission efficiency, reduces latency, and conserves bandwidth, enabling reliable data exchange in resource-constrained environments.

A technical effect of the aforementioned feature is that the system ensures efficient and adaptive data transmission by dynamically responding to sensor inputs and external requests while optimizing bandwidth through data compression. This enhances real-time processing, reduces latency, and improves overall performance of the system in resource-constrained environments.

Throughout the present disclosure, the at least one audio sensor captures the sound signals and generates corresponding metadata. The processor in each device transmits the data stream and the metadata to the host computing platform over a wired communication network or a wireless communication network. The host computing platform receives this data via its communication interfaces, processes incoming streams, and organizes the metadata to associate each data stream with its respective device. The received information is then used for further analysis, synchronization, or integration with additional computational models.

Next, upon receiving the data stream and the metadata, the host computing platform may apply a triangulation technique to estimate the location of the at least one sound source within the area enclosed by the plurality of devices. In scenarios, where the at least one sound source lies outside the area enclosed by the plurality of devices, or where triangulation alone is insufficient, the host computing platform may optionally incorporate direction of arrival (DOA) techniques to improve localization accuracy. In some implementations, beamforming techniques may be utilized to determine the direction of arrival (DOA) of the at least one sound source. Moreover, to improve localization accuracy, the host computing platform may apply additional signal processing techniques, such as filtering techniques or sensor fusion, to reduce noise and enhance precision. Optionally, the location of the at least sound source being determined may be dynamically updated in real time as new data streams and metadata are received, ensuring continuous tracking of the at least one sound source relative to each of the plurality of devices. It will be appreciated that such an approach enables precise localization of the at least one sound source in real-time or near-real-time, thereby enhancing spatial awareness, improving multi-device coordination, and facilitating immersive auditory experiences, such as XR, surveillance, acoustic mapping, and similar.

Upon determining the location of the at least one sound source with respect to each of the plurality of devices, the host computing platform cross-references this data to compute the spatial location of the at least one sound source within the defined coordinate system. Herein, each device amongst the plurality of devices provides its own estimation of position of the at least one sound source based on factors such as TDOA, phase difference of arrival, amplitude-based triangulation, or direction of arrival (DOA). In this regard, the host computing platform may apply sensor fusion techniques to integrate data from the plurality of devices, improving accuracy and reducing errors caused by environmental factors such as reflections or noise. Moreover, using geometric transformations and triangulation algorithms, the host computing platform translates each relative position into a common global reference frame. By cross-referencing multiple relative location estimates with known positions of the plurality of devices, the host computing platform calculates the spatial location of the at least one sound source. Herein, optimization techniques may be used to refine spatial coordinates and compensate for inconsistencies in individual device measurements. Examples of the optimization techniques may include, but are not limited to, Least Squares Estimation, Kalman Filtering, and weighted averaging algorithms. Such optimization techniques are well-known in the art.

Optionally, the determined spatial location may be dynamically updated as new data streams are received, ensuring continuous and real-time tracking of the at least one sound source. It will be appreciated that by cross-referencing the location estimates from the plurality of devices, the host computing platform ensures accurate determination of the spatial location of the at least one sound source, thereby enabling precise localization, enhanced spatial awareness, improved system synchronization, and immersive auditory experiences in applications such as XR, surveillance, acoustic mapping, and similar.

Optionally, when cross-referencing the determined location of the at least one sound source, the host computing platform is further configured to determine the spatial location of the at least one sound source by triangulating the determined locations from the plurality of devices using their spatial locations and orientations within the environment. Triangulation using known device positions yields the absolute position of the source.

In this regard, to determine the spatial location of at least one sound source within the environment, the host computing platform may first obtain individual location estimates from the plurality of devices based on their respective audio measurements. Each device may locally estimate the direction or relative position of the at least one sound source using audio features such as time-of-arrival or signal amplitude. Subsequently, the host computing platform may cross-reference these independently determined relative estimates. In other words, the host computing platform may compare and combine the estimates from each device, taking into account their known spatial locations and orientations within the environment. This cross-referencing allows the system to perform triangulation, wherein multiple lines of bearing or time-based estimates are used to compute the absolute position of the at least one sound source. In this regard, triangulation process may involve utilizing the determined location of the at least one sound source from the plurality of devices in conjunction with their spatial locations and orientations within the environment. Using triangulation technique, the host computing platform computes the spatial location of the at least one sound source by intersecting multiple relative position estimates. Herein, mathematical transformations may be applied to convert each device's relative measurement into a common global reference frame. The triangulation technique, such as multilateration or least squares estimation, may be used to resolve absolute coordinates (i.e., x, y, z) of the at least one sound source within the environment. Herein, the multilateration and the least squares estimation are directly relevant to audio-based localization when time difference of arrival is used. In an audio system with multiple audio sensors, when a sound is emitted, it arrives at each audio sensor at slightly different times. By measuring these time differences, the position of the at least one sound source can be estimated using multilateration. Least squares estimation is then often applied to refine that position by minimizing error between the measured time difference of arrival and predicted values based on a modelled source location. These are common methods in acoustic localization, particularly in systems like microphone arrays, smart speakers, audio-based tracking systems, and similar.

By leveraging the triangulation technique based on the spatial locations and orientations of the plurality of devices, the host computing platform precisely determines the spatial location of the at least one sound source within the environment. This process ensures high-accuracy localization of the at least one sound source, enhances environmental awareness, and supports real-time tracking for applications in spatial audio rendering, XR systems, surveillance, and similar.

A technical effect of the aforementioned feature is that triangulating the location of the at least one sound source using the plurality of devices with known positions and orientations allows for accurate spatial localization of the at least one sound source.

Once the spatial location of the at least one sound source is determined, the host computing platform generates and outputs the spatial audio model. Optionally, the host computing platform is further operable to analyse and utilise the spatial audio model to determine a spatial location and orientation of the at least one sound source in the environment. The platform refines audio source positioning using the spatial model. Spectral features and directionality are extracted to calculate orientation (e.g., voice facing direction). Orientation-aware rendering improves realism, especially in applications involving multiple agents or objects. In this regard, the analysis of the spatial audio model may involve extracting spatial parameters that characterize the position and directional attributes of the at least one sound source within the unified spatial coordinate system. The extracted parameters may include positional coordinates (i.e., x, y, z), directional vectors, phase differences, intensity gradients, time-of-arrival data, frequency-dependent propagation characteristics, and the like. Herein, to determine the spatial location of the at least one sound source, the host computing platform may employ signal processing techniques such as TDOA, frequency domain analysis, triangulation technique, or machine learning-based localization models. The spatial location determination process may involve correlating multiple sound signals received by the at least one audio sensor, mapping these sound signals within the unified spatial coordinate system, and refining the estimated location using the filtering techniques to minimize noise and errors. Optionally, to determine the orientation of the at least one sound source, the host computing platform may analyse directional sound emission patterns, variations in sound intensity across multiple detection points, phase shifts, or multi-microphone phase differences. Directionality estimation techniques such as beamforming, eigenvalue decomposition, HRTF processing and the like, may be utilized to refine the orientation data.

Once the spatial location and orientation of the at least one sound source are determined, the host computing platform may utilize said information to enhance spatial audio rendering, adaptive beamforming, immersive auditory scene generation, or real-time environmental mapping. The determined spatial audio data may also be integrated with external systems, such as AR/VR platforms, robotic navigation systems, interactive media applications, and the like, to enable dynamic and context-aware spatial interactions.

A technical effect of analysing and utilising the spatial audio model to determine the spatial location and orientation of the at least one sound source in the environment is that the system can dynamically adapt spatial audio rendering to ensure accurate auditory perception of position and directionality of the at least one sound source. Such an approach enhances spatial immersion in applications such as in AR/VR, XR, and the like, by enabling precise localization and directional audio cues.

Optionally, the spatial audio model is further used to enable interactions between at least one of: the detected sound sources, a virtual object, a virtual agent, in the environment. Temperature affects the speed of sound (~343 m/s at 20 °C). Devices use this data to adjust timing models for more accurate distance calculations. This increases localization precision across environments (indoor vs outdoor, heated vs cold). In this regard, the term “virtual object” refers to a computer-generated object (namely, a digital object). Moreover, the term “virtual agent” refers to an artificial entity that operates within a digital environment to perform autonomous or interactive tasks. The virtual agent may be embodied as an avatar, artificial intelligence (AI) driven character, or intelligent assistant and can engage in real-time interactions with the users, virtual objects, or environmental elements.

Optionally, the host computing platform may utilize the spatial audio model to establish interactions by detecting sound events, i.e., identifying when and where the at least one sound source appears in the environment. Optionally, the host computing platform may utilize said spatial audio model to classify and track the at least one sound source, i.e., differentiating between various sound sources (e.g., a human speech, an environmental noise, object-generated sounds, and the like) and tracking their movement.

A technical effect of the aforementioned feature is that interactions between at least one of: the detected sound sources, the virtual object, the virtual agent, in the environment are dynamically enhanced based on the spatial audio model, thereby enabling more immersive and context-aware experiences.

Optionally, the processor is further operable to determine a direction of arrival of the sound signals, based on an arrangement of the audio sensors with respect to the plurality of devices, and processing of the sound signals, wherein the host computing platform is further operable to determine the direction of the at least one sound source relative to each device using the timestamps. Direction of arrival (DOA) is computed based on timestamp differences across spatially distributed microphones.

In this regard, the phrase “direction of arrival of the sound signals” refers to an angular direction from which an incoming sound wave propagates towards the at least one audio sensor. Moreover, the term “arrangement” refers to a placement, an orientation, and a distance between at least two audio sensors arranged on at least one device amongst the plurality of devices.

Herein, the processor may apply a beamformer algorithm the DOA of the sound signals. The term “beamformer algorithm” refers to a signal processing technique that utilizes an array of audio sensors to selectively focus a sound signal coming from a specific direction by adjusting a phase and an amplitude of each audio sensor's output, effectively enhancing a desired sound signal while suppressing sound arriving from other directions. The beamformer algorithm processes the sound signals from multiple spatially distributed audio sensors to filter, amplify, or spatially separate sound sources based on their direction of arrival. Once the processor determines the DOA of the sound signals, it uses this information to localize the at least one sound source relative to each device within the environment. In this regard, the processor combines the DOA values with localization techniques such as the triangulation technique to determine the position of the at least one sound source in the environment. If multiple known sound sources are present, their relative DOAs across different devices further enhance localization accuracy. The DOA values provide information on how each device is oriented relative to the detected sound sources. By analysing the DOA measurements across multiple sound signals, the processor determines an angular orientation of the at least one sound source. As new sound signals are detected, the processor continuously updates estimation of the position and orientation of the at least one sound source. Optionally, in some implementations, the processor is further operable to determine a direction of arrival of the sound signals, based on a triangulation technique, when the at least one sound source lies within an area enclosed by the plurality of devices. Herein, the term “triangulation technique” refers to a geometric method used to determine a position or a distance of the at least one sound source by measuring angles at which the sound signals arrive at multiple known reference points within the plurality of devices.

It will be appreciated that determining the DOA of the sound signals enables accurate estimation of the at least one sound source without relying on additional external tracking infrastructure, thereby enhancing self-localization capabilities in dynamic environments. It will also be appreciated that by continuously updating position and orientation estimates based on new sound signals, the system provides real-time spatial awareness, which is beneficial for applications requiring dynamic tracking, such as multi-user AR interactions, autonomous drone navigation, hands-free user interfaces, and similar.

A technical effect of the aforementioned feature is that the system enables accurate spatial awareness by determining the direction of the at least one sound source relative to each device without requiring external tracking infrastructure. Such an approach enhances localization, navigation, and interaction capabilities in various applications, including AR/VR, autonomous systems, hands-free user interfaces, and the like.

Optionally, the processor is operable to time-synchronize the plurality of devices, prior to estimating the direction of the at least one sound source relative to the audio sensor. Synchronization (e.g., via NTP, GPS, or shared clock signals) is essential for accurate TDOA across devices. Without it, triangulation suffers. Synchronized timing ensures accurate real-time audio source localization across distributed devices. In this regard, the term “time-synchronize” refers to a process of aligning an internal clocks of the plurality of devices within the system to a common time standard, ensuring that all devices operate based on a consistent temporal framework. The time synchronization allows for precise coordination of data acquisition, processing, and communication across the plurality of devices, minimizing timing discrepancies. Herein, the processor may achieve the time synchronization by utilizing a shared time reference. The term “shared time reference” refers to a common temporal standard or a time source that is used to synchronize clocks of the plurality of devices within the system. The shared time reference provides a unified time framework that all devices adhere to, ensuring consistency in timestamped data, event sequencing, and coordinated operations. The shared time reference may be established through various synchronization techniques, for example, such as Network Time Protocol (NTP) or Precision Time Protocol (PTP) (i.e., synchronizing devices over a network using standardized time protocols), Global Positioning System (GPS) based synchronization, timestamp alignment via wireless communication (i.e., broadcasting periodic time signals or timestamps over a communication channel to synchronize the internal clocks of all devices), and similar. It will be appreciated that the shared time reference is essential for ensuring consistency in comparing timestamps of the detected sound signals across the plurality of devices. If a sound signal reaches two devices at slightly different times due to spatial separation, the shared time reference ensures that the timestamps recorded by both devices are aligned to a common clock. This synchronization allows the system to accurately calculate the time difference between arrival of the sound signals, which is essential for determining parameters such as a sound source localization, relative positioning, and other time-dependent measurements.

A technical effect of time-synchronizing the plurality of devices using the shared time reference is that it enables precise computation of time differences in the arrival of sound signals across spatially distributed devices, thereby facilitating accurate localization of the at least one sound source.

Optionally, the system further comprising at least one temperature sensor communicably coupled to the plurality of devices, and wherein the processor is further configured to:
receive a temperature data from the temperature sensor; and
calibrate a speed of sound in the environment, based on the received temperature.

In this regard, the term “temperature sensor” refers to a sensor configured to measure an ambient temperature of the environment by detecting thermal energy and converting it into an electrical signal. The at least one temperature sensor may operate based on various principles, including resistance variation (e.g., thermistors, resistance temperature detectors, and the like), voltage generation (e.g., thermocouples, and the like), infrared radiation detection (e.g., infrared temperature sensors, and the like). The measured temperature data may be processed by the processor to enable temperature-dependent calibrations, compensations, or control functions within the system. Examples of the at least one temperature sensor may include, but are not limited to, a thermistor, a resistance temperature detector (RTD), a thermocouple, an infrared temperature sensor, a semiconductor-based temperature sensor, and a digital temperature sensor. Moreover, the term “temperature data” refers to the ambient temperature of surrounding environment in which the system operates. The temperature data represents the temperature of an air or a medium surrounding the system, unaffected by any localized heat sources or cooling mechanisms. The temperature data is an essential parameter in various applications, including sensor calibration, thermal management, and environmental monitoring, as it directly influences material properties, signal propagation characteristics, and overall performance of the system.

Herein, the processor is configured to calibrate the speed of sound in the environment based on measured temperature data by utilizing known physical relationships between temperature and propagation velocity of sound waves in a given medium. In an air-filled environment, a speed of sound (c) varies as a function of temperature (T) according to an empirical equation (1);

$$C = {C}_{0} \sqrt{\frac{T}{{T}_{0}}} \qquad ( 1 )$$

wherein, c₀ is a reference speed of sound at a standard temperature (e.g., 343 m/s at 20 °C in dry air,
T is the measured ambient temperature in Kelvin,
T₀ is the reference temperature in Kelvin (e.g., 293.15 Kelvin for 20 degrees Celsius).

Optionally, the processor of each device amongst the plurality of devices being communicably coupled to the at least one temperature sensor, receives real-time temperature data from the at least one temperature sensor and computes an updated value of the speed of the sound using the equation (1). If the environment has varying temperature conditions, the processor may continuously adjust the speed of sound to reflect these changes, ensuring more accurate distance and position estimations. In this regard, the calibrated speed of sound is then used in various computational processes, such as time of arrival calculations, TDoA measurements, localization and tracking algorithms, and similar. By dynamically calibrating the speed of sound, the processor ensures that distance and position calculations of the at least one sound source remains accurate across different environmental conditions, thereby reducing measurement errors caused by temperature fluctuations.

A technical effect of the aforementioned feature is that the system maintains high localization accuracy of the at least one sound source under varying environmental conditions by dynamically calibrating the speed of sound in the environment, particularly when the at least one sound source lies outside the area enclosed by the plurality of devices. In such scenarios, incorporating temperature information helps to improve robustness and adaptability of sound-based positioning methods by reducing errors due to variations in the speed of sound.

Optionally, the metadata further comprises at least one of: an identifier of each of the plurality of devices, a positional and orientation data of each of the plurality of devices, a measured temperature data, and historical information of the at least one sound source. Metadata ensures correct device association, helps model orientation, and allows historical pattern recognition for predictive spatial audio rendering. This supports adaptive behavior (e.g., recognizing recurring sound sources), improving robustness in complex scenes. In this regard, the term “identifier” refers to a unique data attribute assigned to a given device amongst the plurality of devices within the system to distinguish it from others. Herein, the identifier may comprise a numerical, an alphanumeric, an encoded value, such as a serial number, Universally Unique Identifier, or other unique designation, that enables precise recognition and tracking of each device within the environment. It will be appreciated that inclusion of the identifier for each device enables efficient device management, seamless data association, and unambiguous tracking within the environment, thereby enhancing scalability and interoperability of the system.

Moreover, the term “positional data” represents absolute or relative coordinates of each of the plurality of devices within the defined coordinate system. The positional data may be derived from Global Positioning System (GPS), inertial measurement units (IMUs), optical tracking, or other localization methods. The term “orientation data” refers to an angular alignment of each of the plurality of devices relative to a reference axis or a plane. The orientation data may be expressed in terms of Euler angles (i.e., a roll, a pitch, a yaw), quaternions, or rotation matrices, and may be obtained using gyroscopes, magnetometers, accelerometers, and similar. Herein, the positional and orientation data of each of the plurality of devices is in six degrees of freedom (6DoF). It will be appreciated that the positional and orientation data provide a precise 6DoF representation of each device, allowing for accurate spatial mapping, real-time localization, and improved alignment in dynamic environments.

Moreover, the measured temperature data refers to numerical information representing the temperature of the surrounding environment, obtained through the at least one temperature sensor. It will be appreciated that the measured temperature data facilitates real-time environmental adaptation by enabling dynamic compensation for temperature-induced variations, such as calibrating the speed of sound to maintain accuracy in distance measurements.

Moreover, the term “historical information” refers to previously recorded data associated with the at least one sound source over time. Herein, the historical information of the at least one sound source may include past location coordinates, movement patterns, acoustic signal characteristics, timestamps of previous detections, or environmental conditions during prior detections. The historical information is utilized for trend analysis, predictive modeling, system optimization, and improving accuracy of localization and tracking algorithms. It will be appreciated that historical information allows for predictive modeling and trend analysis, thereby improving robustness of the system by leveraging past data to enhance future estimations, optimize signal processing, and refine localization algorithms.

A technical effect of the aforementioned feature is that the system improves accuracy and reliability of sound-based localization, tracking, and analysis by incorporating at least one of: device-specific identifiers, the positional and orientation data, the measured temperature data, the historical information. This results in enhanced adaptability to environmental variations, improved synchronization across the plurality of devices, and more accurate real-time positioning of the at least one sound source.

Optionally, the system further comprising at least one source of the sound signals, wherein the at least one source comprises at least one of: an ultrasonic beacon, a speaker, a movable object whose movement generates a sound. Ultrasonic beacons may emit inaudible signals for localization. Moving objects (like a user's footstep) can be passive sources. Devices detect and classify them accordingly. This allows flexibility in source types and supports passive sensing without hardware changes. In this regard, the term “ultrasonic beacon” refers to a device configured to emit ultrasonic signals, which are sound waves with frequencies above human hearing range (i.e., above 20 kiloHertz (kHz)). The ultrasonic beacon generates and transmits these signals at predefined intervals for detection by the at least one audio sensor within the system. Herein, the system further comprises the at least one source of the sound signals, which may be an active emitter (e.g., an ultrasonic beacon, a speaker, and similar), a passive emitter (e.g., a moving object generating sound naturally, and the like). Herein, if the at least one source may be the ultrasonic beacon, the speaker, it may periodically emit predefined signals. Optionally, if the at least one source may be the moving object, a sound signal may be generated through motion-induced noise, such as footsteps or mechanical vibrations. Optionally, if the at least one source may be the user wearing the given device that produces sound, i.e., a user wearing the HMD device produces sound, for example, such as a speech of said user. In an implementation, using the sound signals captured by the at least one audio sensor, the processor is configured to determine at least one of: the location of the at least one source, the distance of the at least one source by performing signal processing and spatial computation techniques. Herein, the processor first detects arrival time of the sound signals at each audio sensor and extracts relevant timing information, such as the TDoA between different audio sensors. If the absolute transmission time of the sound signals from the at least one source is known, the processor may calculate the distance of the at least one source based on time delay and the known speed of the sound in the environment. Optionally, if the at least one audio sensor detects the sound signals, the processor determines relative time differences and applies the triangulation technique or the multilateration technique to estimate the location of the at least one source within the environment. When the at least one source of the sound signals emits sound signals periodically or moves within the environment, the processor refines location estimates over time by integrating multiple measurements. Additionally, if the at least one source of the sound signals may be associated with a known device, the processor may retrieve stored position information to enhance localization accuracy. It will be appreciated that by incorporating both active sound sources and passive sound sources, including user-generated sounds, the system ensures robust adaptability to various acoustic environments, thereby reducing reliance on predefined signal patterns. A technical effect of the aforementioned feature is that the system enables real-time localization of the at least one sound source without relying on external positioning systems, enhancing spatial awareness in dynamic environments.

The present disclosure also relates to the second aspect as described above. Various embodiments and variants disclosed above, with respect to the aforementioned first aspect, apply mutatis mutandis to the second aspect.

Optionally, the method further comprising determining the direction of the at least one sound source relative to each device by determining a time difference of arrival of the sound signals using the timestamps, wherein a direction of arrival of the sound signals is determined, based on an arrangement of the audio sensors with respect to the plurality of devices, and processing of the sound signals. This adds DOA estimation to the method, using per-device angle estimation and timestamp analysis. It complements triangulation and improves overall spatial model. In practice, this enhances angular accuracy of sound placement and improves the responsiveness of audio-driven interactions.

### DETAILED DESCRIPTION OF THE DRAWINGS

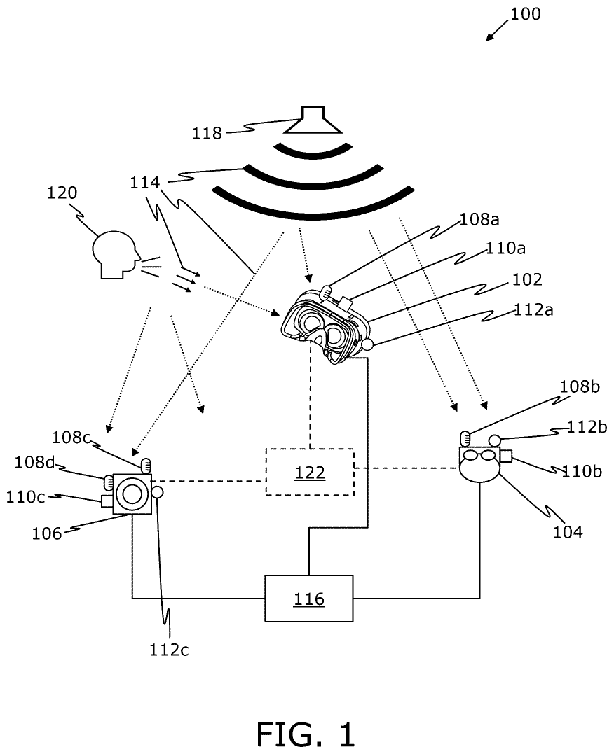

Referring to FIG. 1, illustrated is an exemplary schematic illustration of an environment 100 where a system for reconstructing audio present in said environment 100 is used, in accordance with an embodiment of the present disclosure. The system comprises a plurality of devices (for example, depicted as devices 102, 104, and 106), wherein each device amongst the devices 102, 104, and 106 comprises at least one audio sensor, at least one location sensor, and a processor. For example, device 102 comprises the at least one audio sensor (depicted as an audio sensor 108a), at least one location sensor (depicted as a location sensor 110a), and a processor 112a. Similarly, device 104 comprises an audio sensor 108b, a location sensor 110b, and a processor 112b. Similarly, device 106 comprises audio sensors 108c and 108d, a location sensor 110c, and a processor 112c. Herein, each audio sensor 108a-d is operable to detect sound signals 114 incident thereon. Similarly, each location sensor 110a-c is operable to determine a location of each of the devices 102, 104, and 106 in the environment 100. The processor 112a-c is operable to process the detected sound signals 114 and generate a data stream comprising the sound signals 114 and a metadata, wherein the metadata comprises timestamps of the detected sound signals 114 and the location data of each of the devices 102, 104, and 106. Next, the processor 112a-c is operable to transmit the generated data stream to a host computing platform 116 upon occurrence of a predefined condition. As shown, the host computing platform 116 is communicably coupled to each of the devices 102, 104, and 106.

Herein, the host computing platform 116 is operable to receive the data stream and the metadata from each of the devices 102, 104, and 106. Next, the host computing platform 116 is operable to determine a location of at least one sound source (for example, an ultrasonic beacon 118, a sound signal 114 produced by a user 120) relative to each of the devices 102, 104, and 106 based on the received data streams and the metadata. Next, the host computing platform 116 is operable to cross-reference the determined location of the ultrasonic beacon 118, the user 120 relative to each of the devices 102, 104, and 106 to determine a spatial location of said ultrasonic beacon 118 and the user 120. Then, the host computing platform 116 is operable to generate and output a spatial audio model representing the position of said ultrasonic beacon 118 and the user 120 within a unified spatial coordinate system.

Optionally, the system further comprises at least one temperature sensor (depicted as a temperature sensor 122) communicably coupled to each of the devices 102, 104, and 106. Optionally, the processor 112a-c is further configured to receive a temperature data from the temperature sensor 122 and calibrate a speed of sound in the environment 100, based on the received temperature.

FIG. 1 is merely an example, which should not unduly limit the scope of the claims herein. A person skilled in the art will recognize many variations, alternatives, and modifications of embodiments of the present disclosure.

Referring to FIG. 2, illustrated is a block diagram of a system 200 for reconstructing audio present in an environment, in accordance with an embodiment of the present disclosure. Herein, the system 200 comprises a plurality of devices (for example, depicted as devices 202, 204, and 206), and a host computing platform 208. Herein, the device 202 comprises an audio sensor 210a, at least one location sensor (depicted as a location sensor 212a), and a processor 214a. The device 204 comprises an audio sensor 210b, at least one location sensor (depicted as a location sensor 212b), and a processor 214b. The device 206 comprises audio sensors 210c and 210d, at least one location sensor (depicted as a location sensor 212c), and a processor 214c. Herein, each audio sensor 210a-d is operable to detect sound signals in the environment. Similarly, each location sensor 212a-c is operable to determine a location of each of the devices 202, 204, and 206 in the environment. The host computing platform 208 is communicably coupled to each of the devices 202, 204, and 206. The host computing platform 208 is configured to perform various processing operations, as described earlier with respect to the aforementioned first aspect. Optionally, the system 200 further comprises at least one temperature sensor (depicted as a temperature sensor 216) configured to measure ambient temperature of the environment. Optionally, the temperature sensor 216 is communicably coupled to each of the devices 202, 204, and 206.

It may be understood by a person skilled in the art that the FIG. 2 includes a simplified architecture of a system 200 for sake of clarity, which should not unduly limit the scope of the claims herein. The person skilled in the art will recognize many variations, alternatives, and modifications of embodiments of the present disclosure.

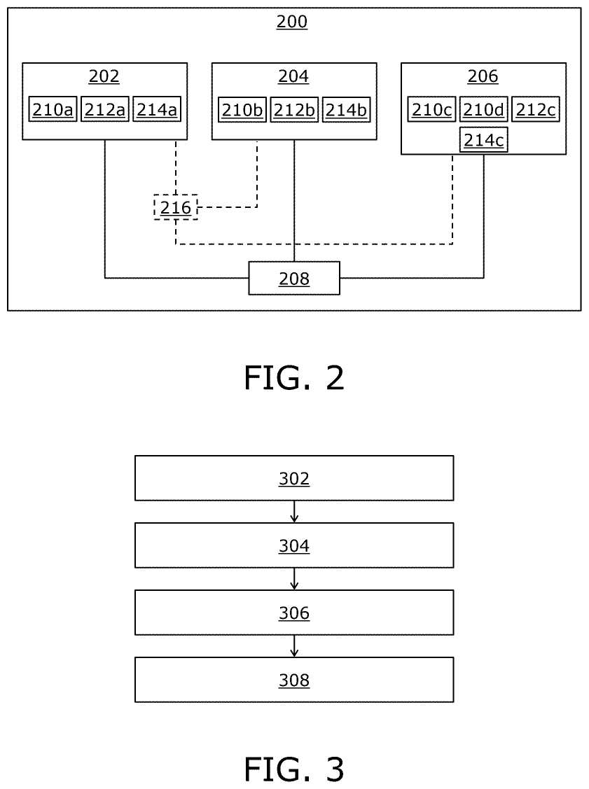

Referring to FIG. 3, illustrated are steps of a method for reconstructing audio present in an environment, in accordance with an embodiment of the present disclosure. At step 302, data stream and metadata are received from each of plurality of devices, the data stream being generated by processing detected sound signals, wherein the data stream comprises sound signals and the metadata, and the metadata comprises timestamps of the detected sound signals and location data of the device, wherein the data stream is received upon occurrence of a predefined condition. At step 304, a location of at least one sound source is determined relative to each of the plurality of devices based on the received data stream and the metadata. At step 306, the determined location of the at least one sound source relative to each of the plurality of devices is cross-referenced to determine a spatial location of the at least one sound source. At step 308, a spatial audio model representing the position of the at least one sound source is generated and output within a unified spatial coordinate system.

The aforementioned steps are only illustrative and other alternatives can also be provided where one or more steps are added, one or more steps are removed, or one or more steps are provided in a different sequence without departing from the scope of the claims herein.

1. A system for reconstructing audio present in an environment, the system comprising:
a plurality of devices, each device comprising:
an audio sensor configured to detect sound signals;
at least one location sensor configured to determine a location of each of the plurality of devices in the environment; and
a processor configured to:
process the detected sound signals and generate a data stream comprising the sound signals and a metadata, wherein the metadata comprises timestamps of the detected sound signals and the location data of the device; and
transmit the generated data stream to a host computing platform upon occurrence of a predefined condition; and
the host computing platform configured to:
receive the data stream and the metadata from the each of the plurality of devices;
determine a location of at least one sound source relative to each of the plurality of devices based on the received data streams and the metadata;
cross-reference the determined location of the at least one sound source relative to each of the plurality of devices to determine a spatial location of the at least one sound source; and
generate and output a spatial audio model representing the position of the at least one sound source within a unified spatial coordinate system.

2. The system of claim 1, wherein the processor is further configured to determine a direction of arrival of the sound signals, based on an arrangement of the audio sensor with respect to the plurality of devices, and processing of the sound signals, wherein the host computing platform is further configured to determine the direction of the at least one sound source relative to each device using the timestamps.

3. The system of claim 1, wherein the predefined condition comprises at least one:
detecting, at the processor, that a triggering condition has been met, wherein the triggering condition is based on an input signal from one or more sensors, and in response, transmitting the data stream to the host computing platform;
receiving, at the processor, a request from the host computing platform to transmit the data stream;
compressing the data stream before transmission.

4. The system of claim 1, wherein the location data from the location sensor is dynamically updated to reflect changes in the position of each of the plurality of devices.

5. The system of claim 1, wherein the host computing platform is further configured to analyse and utilise the spatial audio model to determine a spatial location and orientation of the at least one sound source in the environment.

6. The system of claim 1, wherein the spatial audio model is further used to enable interactions between at least one of: the detected sound sources, a virtual object, a virtual agent, in the environment.

7. The system of claim 1, further comprising at least one temperature sensor communicably coupled to the plurality of devices, and wherein the processor is further configured to:
receive a temperature data from the temperature sensor; and
calibrate a speed of sound in the environment, based on the received temperature.

8. The system of claim 7, wherein the metadata further comprises at least one of: an identifier of each of the plurality of devices, a positional and orientation data of each of the plurality of devices, a measured temperature data, and historical information of the at least one sound source.

9. The system of claim 1, wherein the processor is configured to time-synchronize the plurality of devices, prior to estimating the direction of the at least one sound source relative to the audio sensor.

10. The system of claim 1, further comprising at least one source of the sound signals, wherein the at least one source comprises at least one of: an ultrasonic beacon, a speaker, a movable object whose movement generates a sound.

11. The system of claim 1, wherein the plurality of devices comprise at least two of: a head-mounted display device, a user-interaction controller, a tracking puck, a wearable device.

12. The system of claim 1, wherein the audio sensor comprises at least a microphone, and an acoustic camera.

13. The system of claim 1, wherein when cross-referencing the determined location of the at least one sound source, the host computing platform is further configured to determine the spatial location of the at least one sound source by triangulating the determined locations from the plurality of devices using their spatial locations and orientations within the environment.

14. A method for reconstructing audio present in an environment, a method being implemented by a system comprising a plurality of devices and a host computing platform, wherein each of the plurality of devices comprises an audio sensor configured to detect sound signals, and at least one location sensor, wherein the method comprises:
receiving data stream and metadata from the each of the plurality of devices, the data stream being generated by processing the detected sound signals, wherein the data stream comprises the sound signals and the metadata, and the metadata comprises timestamps of the detected sound signals and the location data of the device, wherein the data stream is received upon occurrence of a predefined condition;
determining a location of at least one sound source relative to each of the plurality of devices based on the received data stream and the metadata;
cross-referencing the determined location of the at least one sound source relative to each of the plurality of devices to determine a spatial location of the at least one sound source; and
generating and outputting a spatial audio model representing the position of the at least one sound source within a unified spatial coordinate system.

15. The method of claim 14, further comprising determining the direction of the at least one sound source relative to each device by determining a time difference of arrival of the sound signals using the timestamps, wherein a direction of arrival of the sound signals is determined, based on an arrangement of the audio sensor with respect to the plurality of devices, and processing of the sound signals.
